(19) United States
(12) Patent Application Publication
(10) Pub. No.: US 2026/0117567 A1
(43) Pub. Date: Apr. 30, 2026

(54) DOOR HANDLE ASSEMBLY FOR A VEHICLE DOOR

(71) Applicant: MINEBEA ACCESSSOLUTIONS ITALIA S.P.A., Pianezza (IT)

(72) Inventors: David PEDROLETTI, PIANEZZA (IT); Antonio ROCCI, Pianezza (IT); Massimo FRATTINI, PIANEZZA (IT)

(73) Assignee: MINEBEA ACCESSSOLUTIONS ITALIA S.P.A., Pianezza (IT)

(21) Appl. No.: 19/367,423

(22) Filed: Oct. 23, 2025

(30) Foreign Application Priority Data
Oct. 29, 2024 (EP) 24209595.8

(51) Int. Cl. E05B 85/10; E05B 79/06; E05B 81/54

(52) U.S. Cl. CPC E05B 85/107; E05B 79/06; E05B 81/54; E05B 85/103

(57) ABSTRACT

A door handle assembly includes: a grip member; an actuation system configured to move the grip member between a flush position, in which the grip member remains flush with an outer surface of a door of a vehicle, and a deployed position, in which the grip member projects from the outer surface, the actuation system comprising a linkage connecting the grip member to a bracket fixed to the door, and an actuator assembly for actuating the linkage to move the grip member; a removable cover part disposed within a handle opening of the door and secured to the bracket by a detachable snap-in connection; and a connector connecting a first wire harness and a second wire harness. The first wire harness is connected to the grip member. The connector is removably attached to an internal side of the removable cover part.

### CROSS-REFERENCE TO RELATED APPLICATIONS

This application claims priority to and the benefit of EP 24209595.8, filed on October 29, 2024, the disclosure of which is incorporated herein by reference.

### FIELD

The present disclosure relates generally to vehicles and, more particularly, to a door handle assembly for a vehicle.

### BACKGROUND

The statements in this section merely provide background information related to the present disclosure and may not constitute prior art.

Handle assemblies for vehicle doors generally comprise a handle, a bracket to which the handle is secured, and mechanical and/or electronic means configured to unlock the vehicle door and to activate a latch to open the vehicle door.

Handles for vehicle doors are components having a significant influence on the style of vehicles.

In this respect, vehicle manufacturers often seek to arrange the handle in the plane of the vehicle door so that it occupies a flush position also called a flush arrangement. A flush handle generally renders the handle as invisible as possible. Moreover, flush handles have the advantage of reducing the aerodynamic noise caused by the rush of air as the vehicle is being driven along.

A flush handle generally comprises a grip member configured to cooperate with a latch mechanism so as to unlatch the vehicle door. The grip member is movable between a flush position in which it extends flush to an external panel of the vehicle door, a deployed position in which it projects with respect to the external panel and becomes graspable, and an open position in which it cooperates with the latch mechanism to unlatch the vehicle door.

The grip member is generally connected to an actuator configured to move the grip member to the deployed position so that a user can grasp the grip member to open the vehicle door. This type of flush handle is called a motorized flush handle.

The grip member of a motorized flush handle is generally equipped with various electronic components, such as sensors. The electronic components are connected to the handle assembly via a connector and a wire harness. The connector is located in the grip member.

It is generally needed, in particular for maintenance purposes, that the grip member may be easily disassembled.

However, the handles assemblies are becoming more and more complex, and the grip members include more and more electronic components; which renders difficult to integrate the connector within the grip member. It may therefore be easier to integrate the connector within the handle assembly, in the vicinity of the grip member.

However, locating the connector outside the grip member can render more complex the disassembling of the grip member from the outside of the vehicle, that is, without disassembling the inner door panel.

### SUMMARY

This section provides a general summary of the disclosure and is not a comprehensive disclosure of its full scope or all of its features.

An object of the invention is to provide a flush motorized handle having a grip member which can be easily disassembled from outside of the vehicle, even when a connector connecting the electronic components is located outside from the grip member.

To this end, a door handle assembly for a door of a vehicle constructed in accordance with the teachings of the present disclosure includes: a grip member; an actuation system configured to move the grip member between a flush position, in which the grip member is intended to remain flush with an outer surface of a door of a vehicle, and a deployed position, in which the grip member is intended to project from an outer surface of a door of a vehicle, the actuation system comprising a linkage connecting the grip member to a bracket intended to be fixed relative to the door, and an actuator assembly configured to actuate the linkage to move the grip member; a removable covert part intended to be disposed within a handle opening of a door of a vehicle, so that an external side of the removable part is visible from the outside when the grip member is in its deployed position; and a connector connecting a first wire harness and a second wire harness. The first wire harness is connected to the grip member. The connector is removably attached to an internal side of the removable cover part. The removable cover part is secured to the bracket by a detachable snap-in connection.

The handle assembly may comprise the following features, considered either alone or in any technically possible combination:

The removable cover part includes clips and the bracket includes corresponding retaining elements, such as lugs or recesses.

The removable cover part includes four clips which constitute hooks and are all oriented towards the same direction.

The clips of the removable cover part are L-shaped.

The connector is secured to the removable cover part by a detachable snap-in connection, either directly or via a removable intermediate support.

The removable cover part is plate shaped.

The actuator assembly includes an electric rotary actuator and an output member, such as a cam, configured to move the second lever from a first position, in which the grip member is in the flush position, to a second position, in which the grip member is in the deployed position.

The linkage includes an elastic biasing device, the elastic biasing device being configured to bias the second lever towards its first position.

The actuator is a non-reversible actuator.

The invention also relates to a vehicle comprising a door handle assembly as disclosed above.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a vehicle equipped with handle assemblies according to the invention;

FIG. 2 illustrates a handle assembly according to the invention;

FIG. 3 illustrates the grip member of the handle assembly of FIG. 2, the grip member being in the flush position;

FIG. 4 illustrates the grip member of the handle assembly of FIG. 2, the grip member being in the deployed position;

FIG. 5 illustrates a part of the handle assembly mounted on a vehicle door, when the grip member is disassembled; and

FIG. 7 to 12 illustrate the steps required to disassemble a grip member of a handle assembly according to the invention, wherein:

FIG. 7 shows a step of detaching a grip member from first and second levers;

FIG. 8 shows a step of removing a removable cover part by sliding the removable cover part in a direction indicated by arrow A1;

FIG. 9 shows a step of pulling the removable cover part away from the bracket in a direction indicated by arrow A2;

FIG. 10 shows a step of flipping the removable cover part to access the internal side;

FIG. 11 shows a step of removing a connector from an intermediate support as shown in a direction indicated by arrow A3; and

FIG. 12 shows a step of separating two connector parts as shown in a direction indicated by arrow A4.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

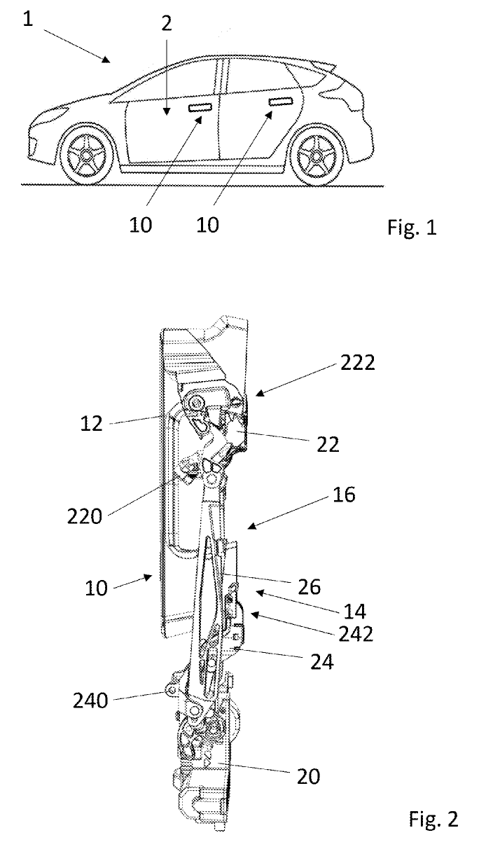

FIG. 1 illustrates a vehicle 1 having at least one door 2 equipped with a motorized flush handle assembly 10 according to the invention.

FIG. 2 to 12 illustrate an embodiment of the handle assembly 10 according to the invention, as well as the steps required to disassemble a grip member 12 of the handle assembly.

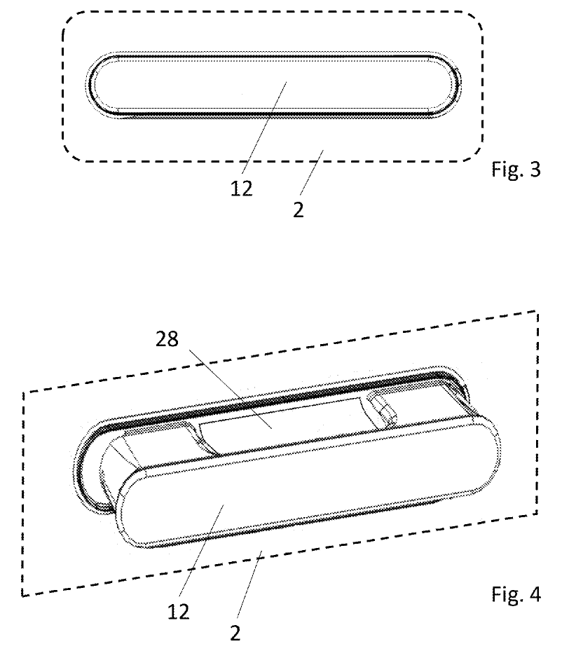

FIG. 2 is an elevation view of a door handle assembly 10, according to the invention. The handle assembly 10 includes a grip member 12 and an actuation system 14. The actuation system 14 is configured to move the grip member 12 between a flush position, in which the grip member 12 remains flush with an outer surface of a door 2 of a vehicle 1, and a deployed position, in which the grip member 12 projects and is offset from the outer surface of the door 2. As shown in FIG. 3, the grip member 12 is, in the flush position, flush (or substantially flush) with the outer surface of the door 2. As shown in FIG. 4, the grip member 12 is, in the deployed position, offset from the outer surface of the door 2. The deployed position allows the grip member 12 to be grasped by a user to open the door.

The actuation system 14 further comprises a linkage 16, connecting the grip member 12 to a bracket 18 (shown in FIG. 9) intended to be fixed relative to the door 2, and an actuator assembly 20 configured to actuate the linkage 16 to move the grip member 12 between the flush position and the deployed position, and conversely. The linkage 16 comprises a first lever 22 and a second lever 24, each of the first and second levers 22, 24 being hinged at a first end 220, 200 to the bracket 18 and being hinged at an opposite, second end 222, 242 to the grip member 12. In the embodiment of FIG. 2, the first and second levers 22, 24 are configured as a parallelogram mechanism. Providing a linkage 16 configured as a parallelogram mechanism allows the grip member following a circular translation motion between its flush and deployed position.

The first lever 22 and the second lever 24 may be linked together by one or two linking member(s) 26. In the embodiment of FIG. 2, the handle assembly comprises two linking members 26, each of them being rotatably connected at a first end to the first lever 22, and rotatably connected at an opposite, second end to the second lever 24.

FIGS. 3 and 4 show the door 2 of the vehicle 1 of FIG. 1, the grip member 12 of the handle assembly 10 being respectively shown in its flush position (FIG. 2) and in its deployed position (FIG. 3).

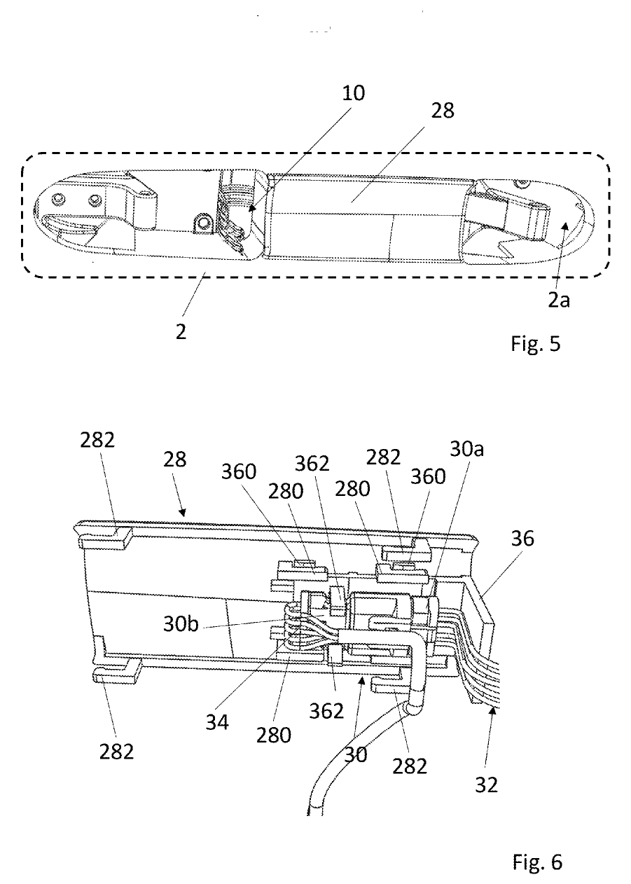

FIG. 5 partially shows the door 2, the grip member 12 being disassembled. As shown in FIG. 5, the handle assembly 10 is located on the internal side of the door 2 and an opening 2a in the door allows the grip member 12 to be located on the external side of the door, while being connected to the remainder of the handle assembly 10.

According to the invention, the handle assembly 10 comprises a removable cover part 28 (which can also be seen in FIG. 4), which allows masking the components of the handle assembly 10 when the grip member 12 is in the deployed position. The removable cover part 28 has therefore an aesthetical function. In the embodiment of FIG. 4, the removable cover part 28 is substantially plate shaped. The removable cover part 28 has an external side, which is oriented towards the same direction as the outer surface of the door 2, and has an opposite, internal side.

FIG. 6 shows the internal side of the removable cover part 28. According to the invention, the removable cover part 28 also has a technical function. The removable cover part 28 provides support for receiving a connector 30 joining a first and a second wire harnesses 32, 34. The first harness 32 connects a first connector part 30a of the connector with electronic components located within the grip member 12 (not shown). The second harness 34 connects a second connector part 30b of the connector with a door ECU (not shown). In the embodiment of the figures, the first connector part 30a is a plug (or male part), and the second connector part 30b is a socket (or female part). In the embodiment of FIG. 6, the connector 30 is not fixed directly to the removable cover part, but is removably fixed to an intermediate support 36, the latter being removably fixed to the removable cover part 28. The intermediate support 36 is removably fixed to the removable cover part 28 by the means of clips 280 fixed to the removable cover part 28, the clips 280 cooperating with corresponding lugs 360 of the intermediate support 36. Further, the connector 30 is removably fixed to the intermediate support 36 by the means of clips 362. Alternatively, the connector 30 may be removably fixed directly to the removable cover part 28, by the means of clips.

In order to removably attach the removable cover part 28 to the remainder of the handle assembly 10, the removable covert part comprises clips 282 cooperating with corresponding retaining elements 180 (shown in FIG. 9), such as lugs or recesses, which are disposed on the bracket 18 of the handle assembly 10. The clips 282 constitute hooks that are all oriented towards the same direction. In the embodiment of FIG. 6, the clips are L shaped. The clips 282 and the retaining elements 180 are configured so that to remove the removable cover part from the bracket 18, an operator must first slide the removable covert part 28 from a locking position, in which the removable covert part remains fixed to the bracket 18, to an unlocking position, in which the removable cover part 28 can be pulled away and separated from the bracket 18.

The configuration of the removable cover part 28 allows an operator to easily remove the connector 30 to disconnect the first and second wire harnesses 32, 34 to fully release the grip member 12 when the latter must be disassembled, as described hereafter.

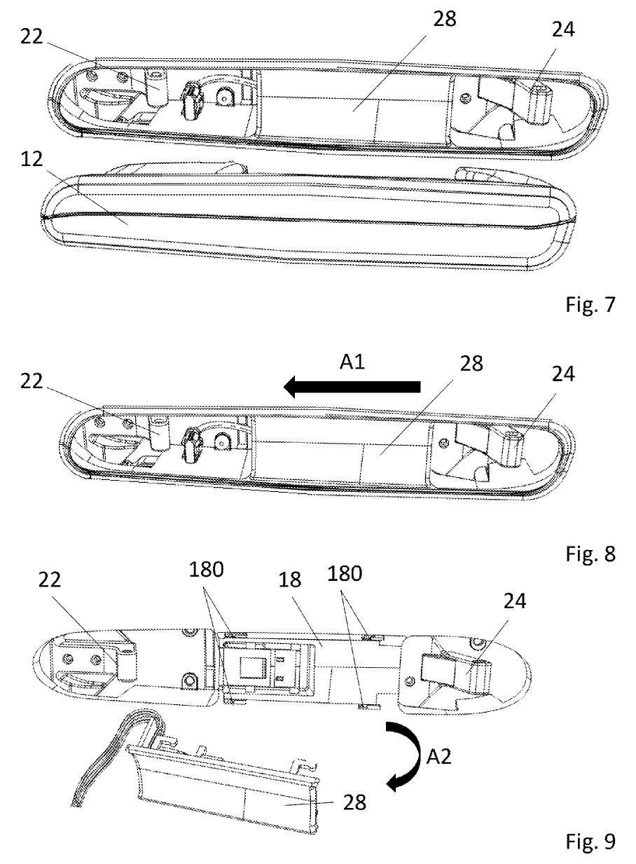

FIGS. 7 to 12 show the steps for disassembling a grip member 12 from the outside of the vehicle, according to the invention.

As shown in FIG. 7, after having (electrically) moved the grip member to its deployed position, a first step includes detaching the grip member 12 from the first and second levers 22, 24. In the embodiment of the figures, the grip member 12 is fixed to the first and second levers 22, 24 by the means of screws, and the first step therefore includes the removal of the screws.

At this stage, the grip member 12 is not connected any longer to the first and second levers, but remains connected to the remainder of the handle assembly 10 by the first harness 32 which is fixed to the connector 30. As shown in FIG. 8, the operator needs to remove the removable cover part 28, by sliding it from its locking position to its unlocking position (in the direction of arrow A1). In the embodiment of the figures, the removable cover part 28 need to be slid towards the left direction. As shown in FIG. 8, the configuration of the removable cover part 28 allows an operator moving this part using only one hand, while keeping the grip member in the other hand.

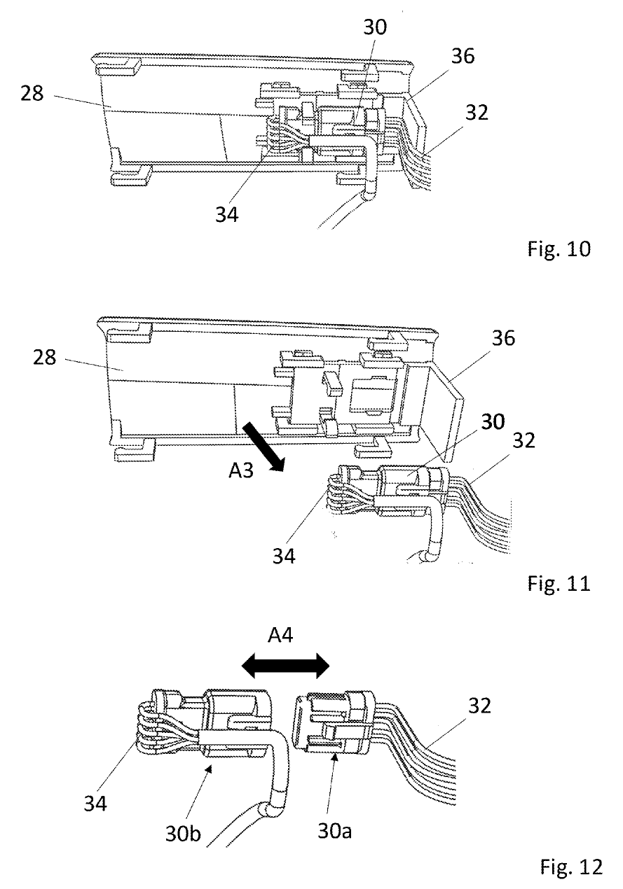

When the removable cover part 28 is in its unlocking position, the operator then pulls the removable cover part away from the bracket 18, as shown in FIG. 9 (arrow A2). The operator is then able flip the removable cover part 28 to access to its internal side (FIG. 10), to remove the connector 30 from the intermediate support 36 (FIG. 11, arrow A3), and eventually to separate the two connector parts 30a, 30b (arrow A4), thereby completing the disassembly of the grip member 12.

When the operator needs to reassemble the grip member to the remainder of the handle assembly, it is needed to perform the reverse the steps described above, that is: connecting the two connector parts 30a, 30b together; attaching the connector 30 to the removable cover part 28 (or to the intermediate support 36); putting the removable cover part 28 back to its unlocking position; sliding the removable cover part 28 to its locking position; attaching the grip member 12 to the first and second levers 22, 24.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A door handle assembly, comprising:
a grip member;
an actuation system, configured to move the grip member between a flush position, in which the grip member is configured to remain flush with an outer surface of a door of a vehicle, and a deployed position, in which the grip member is configured to project from the outer surface, the actuation system comprising a linkage connecting the grip member to a bracket configured to be fixed relative to the door, and an actuator assembly configured to actuate the linkage to move the grip member;
a removable cover part configured to be disposed within a handle opening of the door of the vehicle, so that an external side of the removable cover part is visible from outside when the grip member is in its deployed position; and
a connector connecting a first wire harness and a second wire harness, the first wire harness being connected to the grip member, the connector being removably attached to an internal side of the removable cover part,
wherein the removable cover part is secured to the bracket by a detachable snap-in connection.

2. The door handle assembly according to claim 1, wherein the removable cover part includes clips and the bracket includes retaining elements corresponding to the clips.

3. The door handle assembly according to claim 2, wherein the retaining elements are lugs or recesses.

4. The door handle assembly according to claim 1, wherein the removable cover part includes four clips which constitute hooks and are all oriented towards a same direction.

5. The door handle assembly according to claim 4, wherein the clips of the removable cover part are L-shaped.

6. The door handle assembly according to claim 1, wherein the connector is secured to the removable cover part by the detachable snap-in connection either directly or via a removable intermediate support.

7. The door handle assembly according to claim 1, wherein the removable cover part is plate shaped.

8. The door handle assembly according to claim 1, wherein the actuator assembly includes an electric rotary actuator and an output member configured to move a second lever from a first position, in which the grip member is in the flush position, to a second position, in which the grip member is in the deployed position.

9. The door handle assembly according to claim 8, wherein the output member includes a cam.

10. The door handle assembly according to claim 8, wherein the linkage includes an elastic biasing device, the elastic biasing device being configured to bias the second lever towards its first position.

11. The door handle assembly according to claim 8, wherein the actuator is a non-reversible actuator.

12. A vehicle comprising the door handle assembly according to claim 1.
